(19) United States
(12) Patent Application Publication
(10) Pub. No.: US 2006/0060287 A1
(43) Pub. Date: Mar. 23, 2006

(54) Method of sealing remanufactured split toner cartridges

(76) Inventor: Costa G. Chitouras, Somerville, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/233,499

(22) Filed: Sep. 22, 2005

Related U.S. Application Data
(60) Provisional application No. 60/648,608, filed on Jan. 31, 2005.
(60) Provisional application No. 60/612,419, filed on Sep. 23, 2004.

(51) Int. Cl. B32B 37/00

(52) U.S. Cl. 156/94; 156/581

(57) ABSTRACT

An original equipment type seal for recharged toner cartridges can be installed by splitting the cartridge, placing the toner section of the cartridge in a fixture which can include a track for precision alignment of the seal with the opening to be sealed, having a heated platen with a contact surface typically consisting of portions that are curved and others that may be flat so that when under pressure, the platen makes intimate contact with the seal and seals the toner cartridge, with only temporary minor and not permanent distortion of the cartridge. Better results occur with the cartridge constrained by the use of a precision machined or otherwise adjusted support beneath the toner section of the cartridge. The non-linear design of the platen makes possible the use of the same sealing apparatus for multiple toner cartridges of similar size, such as the generally referred to 2100, 2300, 4000, and 4100 model toner cartridges. In those instances where complete sealing does not occur, the use of a hand-held heated touch-up tool may be used to adhere the localized unsealed spot. While the non-linear design of the platen has been discussed in conjunction with the sealing of split cartridges, it is possible and desirable to utilize a similar concept while inserting seals without splitting the cartridge. This is accomplished by applying solder-tabs onto the blade of the insertion tool and machining the dimensions of the pads to essentially conform to the shape of the non-split cartridge to be sealed. For proper sealing some pressure must be applied to the blade of the insertion tool which may conveniently be accomplished with magnetically supported pins which can be slid into narrow openings in the cartridge and may subsequently be rotated to provide pressure at the desired locations. While the preferred seal can incorporate a low-temperature, “hot-melt” type adhesive on the seal surface that contacts the cartridge surface to be sealed, this invention may be practiced also with the use of pressure sensitive adhesives.

### RELATED APPLICATIONS

This application claims the benefit of U.S. Provisional Application No. 60/648,608, filed on Jan. 31, 2005, which claims the benefit of U.S. Provisional Application No. 60/612,419, filed on Sep. 23, 2004. The entire teachings of each of the above applications are incorporated herein by reference.

### BACKGROUND OF THE INVENTION

A series of U.S. and foreign patents describing the invention of sealing remanufactured toner cartridges without splitting the cartridges have been issued to the applicant and such disclosures have been described in U.S. Pat. Nos. 5,370,761; 5,460,674; 5,876,541; and 6,596,110 ('761, '674, '541, and '110 patents) and their foreign equivalents. The teachings of each patent are incorporated herein by reference. Despite the fact that the teachings of these patents, i.e., without splitting the cartridges, are acknowledged to be the technically preferred methods of sealing used and depleted toner cartridges, primarily because of the retention of the factory alignment and the ultimate performance and appearance of these remanufactured cartridges, there is significant commercial value to offering to the industry a very fast, universal method of sealing split cartridges with the added virtue of an inherent means of almost instantaneously visually verifying the sealing efficacy of such sealed split cartridges. The major commercial value stems from the fact that despite superior inherent performance characteristics in utilizing the patented non-split cartridge technologies, the competition among the many methods of sealing split cartridges and the significant advertising of these many available seal types has created a large source of previously sealed, split cartridges, available for resealing.

However, most remanufacturers hesitate to use previously sealed (non virgin) cartridges, in spite of their availability and low cost because of the net cost of preparing these non virgin cartridges for resealing. This preparation usually involves the removal, with some difficulties, of residual adhesive, plastic gaskets and/or foam before a new seal designed for split cartridges can be installed. Having the availability of a simple-to-operate sealing apparatus, almost totally unaffected by the residual remains from multiple sealings of a cartridge and a sealing time shorter than any available at present makes a very desirable commercial product. A comparison of the differences of the two methods of sealing, with and without splitting the cartridge, is most apparent after one reviews the aforementioned patents.

### SUMMARY OF THE INVENTION

A device for resealing a toner cartridge includes a base for positioning a split toner cartridge. The split toner cartridge has a toner cartridge surface for receiving a replacement seal and adhesive. A platen having a platen surface is substantially aligned with the toner cartridge surface for receiving the replacement seal and adhesive when the platen is pressed against the toner cartridge surface. The platen includes a portion that varies in elevation over at least part of the platen surface.

A platen for resealing a toner cartridge includes a raised surface which corresponds substantially with the toner cartridge surface for receiving a replacement seal and adhesive. The raised surface of the platen varies in elevation over at least a portion of the platen surface.

A method for resealing a toner cartridge includes positioning a split toner cartridge in a base. The split toner cartridge has a toner cartridge surface for receiving a replacement seal and adhesive. A seal is positioned with an adhesive attached thereto so that the adhesive is in contact with the toner cartridge surface for receiving the seal and adhesive. A platen having a platen surface that is substantially aligned with the toner cartridge surface for receiving the replacement seal and adhesive is applied. The platen, which includes a portion that varies in elevation over at least part of the platen surface, is pressed against the seal for applying to the toner cartridge, thereby resealing the toner cartridge.

The invention further includes a method for resealing a toner cartridge, having its original seal removed, whereby the toner cartridge can be recharged with toner and resealed for shipping, with previously split cartridges usually having remains of adhesive, plastic gaskets or foam of previously installed seals, and, utilizing a seal which may be essentially identical to the original equipment manufacturer's design and similar to the seals used in sealing un-split recharged toner cartridges described in the above indicated patents. The method includes placing a split cartridge into a fixture that preferentially includes a track for precision alignment of a seal with the opening to be sealed in the toner cartridge, placing a seal in this track and sliding it so as to align it with the opening of the cartridge so that the adhesive on the bottom of the seal covers the surfaces of the cartridge that is to be sealed.

The fixture also includes a movable heated platen with a contact surface that is lowered onto the seal and adhesive for sealing to the cartridge. The contact surface consists of portions that are curved or non-linear or both and other portions that may be flat, so that, under the relatively low pressure of the platen, continuous contact is made between the platen, seal and cartridge surfaces with only minor and not permanent distortion of the cartridge. Better results occur when the cartridge is constrained and supported by the use of a precision machined or otherwise adjusted support beneath the toner section of the cartridge. The non-linear design of the contact surface of the platen makes possible the use of a single sealing apparatus for multiple toner cartridges of similar size, such as the generally referred to 2100, 2300, 4000, and 4100 toner cartridges.

After heating the seal with the platen and melting the adhesive, the platen is raised, allowing the hot-melt adhesive to cool and the cartridge is removed for filling with toner and assembly of other components to the cartridge. While lifting the cartridge from the fixture, a visual inspection is possible to determine a complete seal or a defective one, detected by a telltale change in color (usually black) at all places that the seal and adhesive are glued to the toner surface. In the event the seal indicates a small leak, a hand-held heated tool may be provided, as part of the heated platen, to touch-up the leak. The total time from picking up the cartridge, placing it into the fixture, aligning a seal over the cartridge, lowering the platen for about five seconds and releasing the platen and picking up the cartridge and inspecting it for proper sealing is typically fifteen seconds. When this same cartridge is again recycled and is sealed, only a cursory cleaning of the residual toner is necessary. The adhesive remaining on the cartridge melts and is incorporated into the new seal adhesive. While the preferred seal would incorporate a low-temperature, “hot-melt” type adhesive on the seal surface that contacts the cartridge surface to be sealed, this invention may be practiced with the use of other adhesives, e.g., a pressure sensitive adhesive, with small variations in the equipment design or usage.

The non-linear design of the platen is applicable to the insertion blade of the aforementioned issued patents with the use of solder tabs on the blade, which are machined to varying heights to provide constant contact of the blade to the seal/cartridge surfaces to be sealed, such contact being further assured with the use of pressure forces on various portions of the blade of an insertion tool.

An insertable blade for sealing a toner cartridge a plurality of raised pads. The pads can be are formed from solder.

A system for applying pressure to an object, includes a block. A pin is formed from a magnetic material and is longitudinally slidable through the block and rotatable within the block about its axis. The pin can contact the object. The pin has a handle at the proximate end. The handle is shaped to engage the block and limit passage of the pin through the block. A first magnet is positioned to magnetically engage the pin and hinder longitudinally movement of the pin along the axis. A second magnet is positioned to magnetically engage the handle in place against the block. A toner cartridge resealing device can have a plurality of systems for applying pressure to an insertable blade against a seal and toner cartridge.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic illustration of a preferred version of a universal split sealer.

FIG. 2 is a schematic illustration of a preferred version of the platen for a universal split sealer.

FIG. 3 is a schematic illustration of a preferred version of a cartridge restrainer for a universal split sealer.

FIG. 4 is a schematic illustration of a preferred version of a heated tool for repairing any unsealed localized portion of an otherwise sealed cartridge.

FIG. 5 is a schematic illustration of a preferred version of a 3-D modification to flexible heated tools to generate a multi-curved surface on the thin insertion tools used to practice the processes described in the U.S. Pat. No. 5,370,761 producing results similar to the platen in FIG. 3.

FIG. 6A is a schematic representation of a preferred version of a pressure system consisting of a pressure pin and magnetic bearing block.

FIG. 6B is a sectional view of a preferred version of a pressure pin and magnetic bearing block.

### DETAILED DESCRIPTION OF THE INVENTION

A description of preferred embodiments of the invention follows.

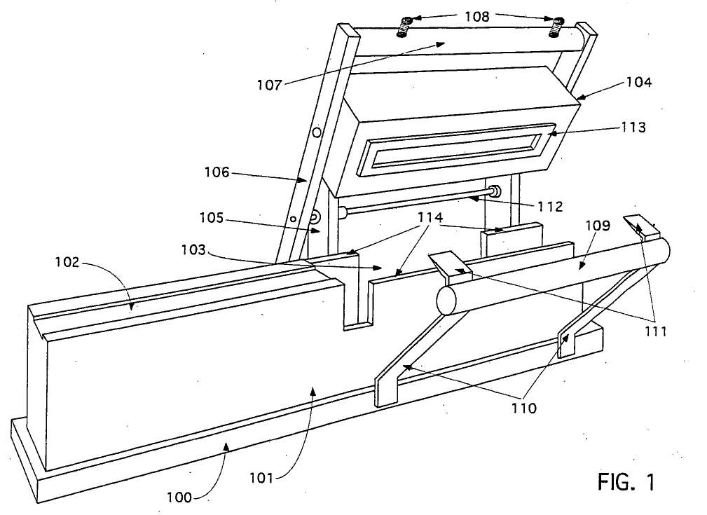

A schematic representation of the preferred apparatus for practicing this invention is shown in FIG. 1. It can be seen that base 100 is attached to seal/cartridge holder 101 into which is machined seal track 102 which is lined up with the cartridge cavity 103. Also attached to base 100 is the heater assembly 104 with the support member(s) 105 and 106 to allow heater assembly 104 to swing down onto the cartridge (not shown) to be sealed, which is supported in the cartridge cavity 103 in the normal operation of this apparatus. Pull-down arm 107 with arm stop(s) 108 is attached to support member(s) 106. To facilitate a low but firm and steady force onto the seal (not shown) during the normal operation of this apparatus, hold-down arm 109 with flat spring(s) 110 hold cam(s) 111. The heater assembly 104 rotates about an axis on shaft 112 when pull-down arm 107 is pulled towards and under cams 111. Additional detail design features of platen 113, which is attached to heater assembly 104, as well as top cartridge support(s) 114, which form the top cartridge supports mechanism for cartridge cavity 103 and other preferred modifications and embellishments will be described in subsequent paragraphs and figures below.

A method of using this apparatus is as follows. The toner section of a split cartridge is placed into and supported by the cartridge cavity 103. There is no ambiguity in the placement of the cartridge as it only fits in one position. A seal, described in the aforementioned issued patents, but typically consisting of a long (e.g., about 58.4 cm or 23 inches), narrow (e.g., about 3.6 cm or 1.425 inches) and thin (e.g., about 0.075 mm or 3 mils) polyester film which is coated with a low-melt-temperature, hot-melt adhesive at least on the underside of the film that contacts the surface of the cartridge that is to be sealed. The surface of the toner cartridge for receiving the seal and adhesive is essentially flat. With this apparatus, the seal may also be coated in areas that do not contact the surface of the cartridge that is to be sealed. As described in the aforementioned patents, an adhesive that softens/melts at temperatures typically between about 60° C. to 82° C. (140° F. to 180° F.) is preferred so as to be above the recommended storage temperature of the cartridge and below the distortion temperature of the cartridge plastic. This seal is placed in the seal track 102 with the adhesive positioned over the cartridge opening after the cartridge to be sealed is positioned and held firmly in cartridge cavity 103 and supported at top cartridge supports 114.

The operator then places his fingers on pull-down arm 107 and his palms and thumbs on and under of the hold down-arm 109, respectively, such that cam(s) 111 ride over pull-down arm 107 resulting in a relatively high force of the platen onto the seal-adhesive-cartridge sandwich, yet requiring little force by the operator because of the action of cam(s) 111. Using a heated platen operating at about 110° C. (230° F.) and a sealing time of about five seconds is sufficient to melt the adhesive and seal the seal to the cartridge. A platen operating temperature of about 110° C. (230° F.) does not thermally distort the cartridge because the temperature is still below the distortion temperature of the plastic used in cartridges and more importantly, the dwell time of the platen onto the seal/adhesive/cartridge is not sufficient to raise the temperature of the cartridge much above the melt temperature of the adhesive. There are other methods of transporting a heated platen to the cartridge surface but the apparatus described above satisfies the desires for a simple, reliable, precise and safe, as well as low cost mechanism.

While a simple, perimeter flat platen is shown in FIG. 1 and discussed in the preceding paragraph, split toner cartridges are known for being (relatively) flexible, and becoming even more so with new, lighter-weight and lower-cost model introductions, and consequently, a simple, flat heated platen does not provide adequate or consistent sealing because of the distortion of the cartridge surface under the force of the heated platen whereby the heated platen remains flat and does not make intimate contact with the seal-adhesive-cartridge sandwich. However, a force that even slightly distorts the cartridge, beyond a cartridge's own irregularities, should allow the platen to effectively match the distorted shape of the cartridge-sealing surface when being sealed to a level of a true hermetic seal, as is achieved with the non-split, insertable heat-sealing system described in the aforementioned patents. A second reason for a redesign of the platen geometry for the apparatus described in FIG. 1 is the successful development of a universal cartridge holder design for split 2100, 2300, 4000 and 4100 cartridges, with automatic alignment of the seal with the same seal track for all the four above mentioned cartridges. A need existed for a system that would allow a particular platen design to seal at 100% repeatability for a variety of cartridges, with the only seal failure tolerable being a badly deformed cartridge or defective seal.

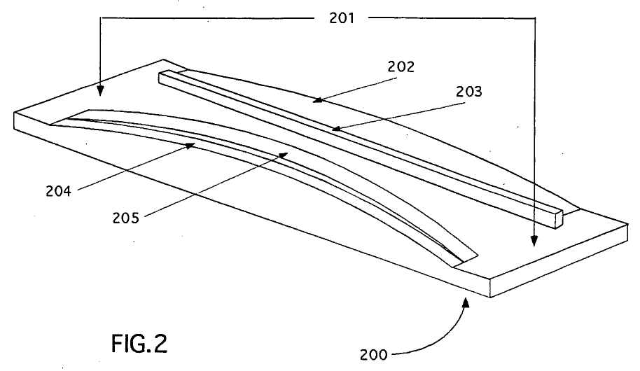

FIG. 2 is a schematic representation of a platen 200 designed for practicing this invention so as to reliably seal, as well as reseal, toner cartridges, and in particular for this example and discussion, four cartridge model types (2100, 2300, 4000 and 4100) with the same apparatus. Similar to the platen 113 in FIG. 1, the short ends 201 of the platen in FIG. 2 may be flat because there is little or no significant distortion in these parts of these cartridges when under the pressure of a heated platen. Contrary to this level of cartridge stability, the long side rails of a cartridge deflect considerably, well beyond the ability of a seal to normally remain in contact with a flat platen and the cartridge-sealing surface. For this particular platen design, four additional surfaces in addition to the short ends 201 surfaces areas were found to address the distortion/sealing mating issues, although other but similar surface designs for the same cartridges can be designed with equally effective results.

The four surfaces are the front arc 202, the hold down bar 203, the first rear arc 204 and the second rear arc 205. To orient the reader, note that the platen 200 is drawn facing upwards so as to see the significant surface designs but, as shown in FIG. 1, the platen is utilized facing downwards to press on the seal/adhesive/cartridge. Therefore, the front arc 202 and the hold down bar 203 actually face the operator when using the apparatus in FIG. 1. Also, the proportions of actual arc sizes are greatly exaggerated in FIG. 2 for the purpose of descriptive clarity. The actual dimensions for the platen in question are as follows. Assuming the surfaces 201 of platen 200 are considered as the “0” reference, front arc 202 reaches a maximum height of 0.5 mm (0.02 inches) above reference, hold down bar 203 has a height of 0.75 mm (0.03 inches) above reference, first rear arc 204 reaches a maximum height of 0.1.25 mm (0.05 inches) above reference and the second rear arc 205 reaches a maximum height of 1.5 mm (0.06 inches) above the zero reference. While these demarcations from a flat platen may appear small, they are important for achieving 100% hermetic sealing.

The platen surfaces developed above were arrived at by an iterative process. There are a number of interactive variables involved, which are more fully described below. However, the choice of the front arc 202 with only a 0.5 mm (0.020 inch) peak indicates that the front part of the cartridge deforms only slightly because it is supported by a long surface support which is part of the top cartridge support(s) 114. Hold down bar 203, at a height of 0.75 mm (0.03 inches), i.e., higher than the front arc 202, is used to press down onto the whole, unsupported seal itself, i.e., inside the opening of the cartridge, causing adhesion of the seal not only on the top of the sealing surface but also along the edge of the opening itself. The first rear arc 204 reaches a peak of 1.25 mm (0.05 inches), indicates a match in the deflection of the cartridge surface greater than at the front. This comes about because of the structure of the cartridge as well as the absence of a level of support of the cartridge by those portions of the top cartridge support(s) 114 at the rear of the cartridge, which was designed in this fashion for the practical purpose of accommodating the four different cartridge types. The second rear arc 205 reaches a maximum height of 1.5 mm (0.06 inches) which serves a similar purpose as the hold down bar 203, but which cannot be a straight bar but a curved arc for effectively sealing the cartridge. One can replace the two arcs 204 and 205 by three or four narrower arcs, which would serve the same purpose as the two arcs 204 and 205. Also, one could replace these two arcs, 204 and 205 by a single three-dimensional arc, with the two arcs blended so as to be one arc, but having a curvature both along the lengths of the two arcs as well as perpendicular to the length direction. However, this is a more complex shape to machine and is not the preferred design for the apparatus under discussion.

The process of pressing the platen onto not only different cartridges of the same type but of different types and from different manufacturers introduces the problem of maintaining a relatively constant stiffness against which the platen presses. The use of a non-linear platen does not imply nor does it produce a fit to the various cartridge-sealing surfaces by permanently molding the cartridges to the platen. The fact is that while the platen does press against the cartridge, the cartridge also bends so that the desired platen shape that actually seals a seal is partially dependent upon the amount of bending the cartridge takes for a particular platen. A successful sealing occurs when the temporarily distorted cartridge under pressure from the platen closely matches the actual platen shape. The requirement for precise matching in this apparatus is greatly reduced because of the presence in the preferred seal design of a relatively thick layer of hot-melt adhesive, typically about 0.05 to 0.076 mm (2 to 3 mils) which flows and fills in voids that are present in matching a given platen design to the variety of deformations that occur in the different cartridges under the platen pressure.

To achieve this matching of the distorted cartridge shape to the platen shape, it has been found that if the bottom of the cartridge is held at a precise dimension with respect to the cartridge support areas (the top cartridge support(s) 114 in FIG. 1), it is a simpler process to design a proper platen shape by minimizing the iterative process, i.e., trying to mate a platen surface with a distorted cartridge surface when for every platen design and for every different pressure of the platen, the cartridge distorts a different amount and at different locations.

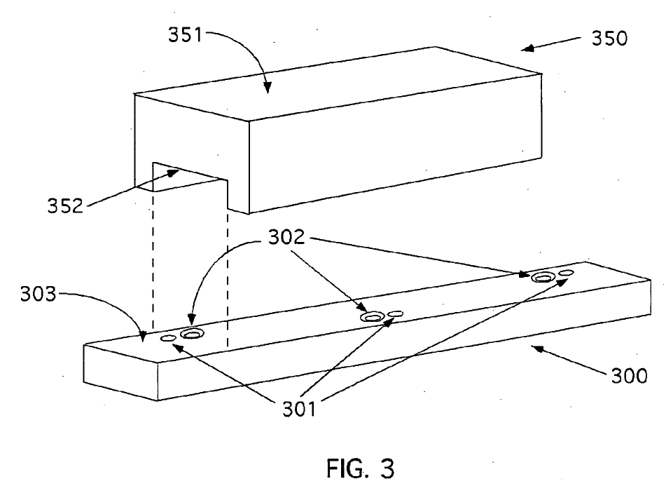

FIG. 3 is a schematic representation of a preferred embodiment of this bottom support 300, which is placed at the bottom of the cartridge cavity 103 in FIG. 1. Bottom support 300 is approximately 1.27 cm high (0.5 inches), 2.54 cm (1 inch) wide and 25.4 cm (10 inches) long, although this length is determined by the length of the cartridges in use. Three tapped holes 301 can be used with threaded studs (not shown) extending through the bottom of bottom support 300 so as to adjust and position the top surface 303 to be a precise distance from the top cartridge support(s) 114 in FIG. 1. The screw clearance holes 302 can be used for the hold down screws (not shown) for holding the bottom support 300 permanently in position after the three threaded studs are adjusted for the proper spacing of top surface 303 to the top cartridge support(s) 114 in FIG. 1. The combination of the three studs in holes 302 and the three screws inserted into screw clearance holes 302 hold the bottom support 300 firmly in place and forms a firm support for the 4000 and 4100 series of cartridges placed within this apparatus.

Because the 2100 and 2300 series of cartridges should be fully supported at the bottom the same as the 4000 and 4100 cartridges in the apparatus in FIG. 1, but do not have the same physical height as the 4000 and 4100 cartridges, an adapter 350 in FIG. 3 has been designed to be placed over bottom support 300 as shown by the dotted lines. By machining the distance between surface top adapter 351 and surface 352 accurately, it is apparent that an equally accurate and effective new bottom support for the 2100 and 2300 cartridges results, and the changeover time from one set of cartridges to the other can be literally carried out in a matter of seconds.

The deflection or distortion experienced by the cartridge to be sealed when placed within the apparatus of FIG. 1 is affected by many factors, but predominantly by the specific characteristics of the cartridge designs, by the platen shapes and dimensions, the specific support system of the cartridge within the apparatus, and, very significantly, by the actual force of the platen against the cartridge when sealing. With reference to FIG. 1, adjustable stops 108 are adjustable and are adjusted to contact hold down-arm 109 and stop further motion of cam(s) 111 over pull-down arm 107, thereby limiting and stabilizing the force applied to the platen against the seal/adhesive/cartridge sandwich. While the apparatus described in this invention is very useful for sealing split cartridges that have been sealed many times before, there is a limit to the ability of this or any equipment to unconditionally seal all previously sealed cartridges with a zero failure rate. In those relatively few instances when a used cartridge does not properly seal at the first attempt, but displays a small “leak” or seal area that is not properly bonded, the use of a heated tool will almost always quickly remedy the failure.

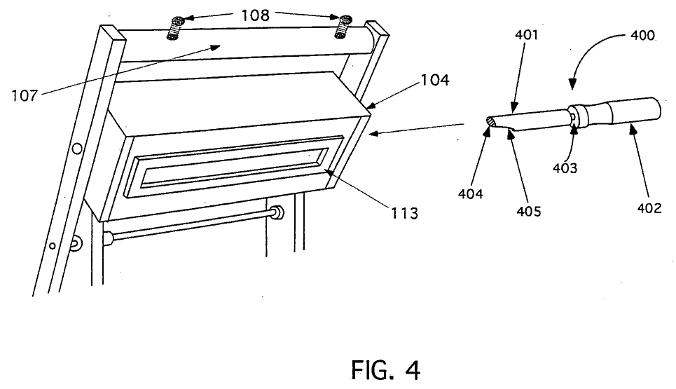

FIG. 4 is a schematic illustration of a preferred version of a heated tool 400 for repairing any localized portion of an otherwise sealed cartridge. The heated tool 400 consists of a rod 401, made typically of a high heat conductive material, such as aluminum, joined to an insulated handle 402 by a threaded support 403. For convenient access to the area to be repaired, an angled surface 404 at the end of the rod 401 is machined, and for further convenience and adaptability to many cartridge designs, a relief near the end 405 in the shape of the rod 401 is provided to further allow reaching into the cartridge cavity. To conveniently and reliably heat the rod 401 of the heated tool 400 to a predictable temperature even when heated tool 400 is only randomly and infrequently used in normal production environments, the use of an aluminum block (not shown) within the heater assembly 104, placed in close thermal contact with the platen 113, with a hole machined into the platen's 113 side for receiving the heated tool 400, will heat said tool and properly maintain the temperature for spot heating the seal/adhesive combination to the cartridge surface to correct any leaks.

If the seals described in the above discussions as having hot melt adhesive on the surface of the film that contacts the surface of the cartridge that is to be sealed, have, in place of the hot melt adhesive, pressure sensitive adhesive (PSA), although typically with a thinner coating, the apparatus described in FIG. 1 may be used to seal a cartridge with a pressure sensitive coated seal by simply not heating the platen, together with a minor adjustment in the placement of the seal onto the cartridge sealing surface. Typically, one could lightly anchor one end of the adhesive coated seal to the end of the cartridge surface to be sealed and then lower the cool platen onto the seal, thus pressing the unattached seal onto the cartridge surface resulting in the subsequent total adhesion of the seal to the cartridge surface taking place. While the same or very similar platen of the preferred embodiment may be used, because no heat transfer between the platen and seal/cartridge is required, a rubber, foam plastic, felt or similar deformable product may be used on the surface of the preferred platen design, or even a flat platen, to press against the PSA coated seal. Similarly, many of the means developed for pressing the insertion tool/seal combinations described in the '761, '674, '541, and '110 patents, such as pressure pads or magnetic structures, are further methods of applying pressure to the PSA coated seal. Other mechanisms may also replace the platen in this description, such as a substantially cylindrical roller rolled along the length of the seal to be attached to the cartridge, adhering the seal to the cartridge wherever roller pressure, adhesive and cartridge surface co-exist.

Almost all of the previous discussions revolved around the sealing of split cartridges with platen designs that are not typically flat over the contact surfaces with the seal, but includes surfaces curved in various shapes, if the highest level of sealing performance and speed are desired. However, I have found that many of the advantages of platen designs for the sealing equipment described in this invention can be similarly incorporated into the insertion tool designs used in the methods for inserting seals described in the '761, '674, '541, and '110 patents, to address changes brought about by the competitive and aggressive nature of the original equipment manufacturers to prevent remanufacturing of toner cartridges. In other words, while a two-dimensional pattern in the insertion tools to seal a typical toner cartridge was previously adequate, it has been found that a three-dimensional design is more effective, both in performance and speed.

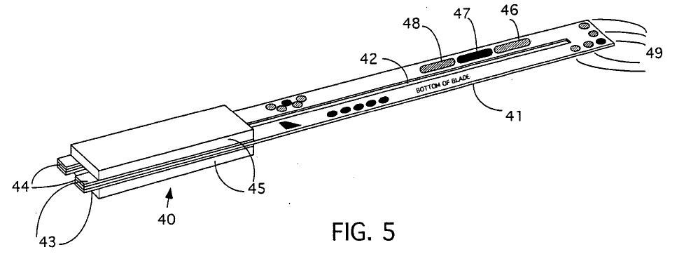

FIG. 5 is a schematic illustration of a typically preferred embodiment of a three-dimensional modification to heated insertion tools to generate multi-curved surfaces on the thin insertion tools used to practice the processes described in the '761, '674, '541, and '110 patents, producing results analogous to the platen in FIG. 2. FIG. 5 is similar (in function) to FIG. 4 in U.S. Pat. No. 5,370,761 but with the addition of solder pads of different surface shapes and heights. More specifically, the element numerals 40 through 45 are common elements in FIG. 5 in this application and FIG. 4 in U.S. Pat. No. 5,370,761, which are insertion tool 40 (shown with the bottom surface on top, for clarity of pad location and designs), blade 41, slit 42, highly conductive metal strips 43, terminals 44, and insulating handles 45. Modified solder pads 46, 47 and 48 in FIG. 5 depict different height pads indicated by the line density patterns, in this case the lighter the line density, the lower the height. For example, low pads 46 might be 0.05 mm (2 mils) high, medium pads 48 might be 0.13 mm (5 mils) high and high pads 47 might be 0.2 mm (8 mils) high. Note that five pad cluster 49 is composed of three different heights, producing a “curved” surface when this portion of the blade is heated and presses on the seal and cartridge surface. With three-axis CNC milling machines, pads 46, 47, 48, and even 49 may have continuous curves on their surfaces for an even more precise match of blade shape to cartridge shape.

Since these pads continually experience some abrasion wear from insertion into and removal from the folded plastic seal while under pressure from the cartridge, a high abrasion “solder” utilizing fine metal-particle-filled solder is preferred for these pads. A preferred product is PMS-A212-800 manufactured by Fusion Incorporated of Willoughby, Ohio U.S.A. By employing such a solder design, the abrasion resistance of the solder pads are effectively equal to the abrasion resistance of the metal particles, for example, the abrasion resistance of steel, copper, nickel or similar metal particles, which have far greater abrasion resistance than the lead and tin in low-temperature solder. Higher abrasion resistance solders typically have much higher melting temperature that make them difficult to use as pads on the thin steel necessarily used for the insertion blades.

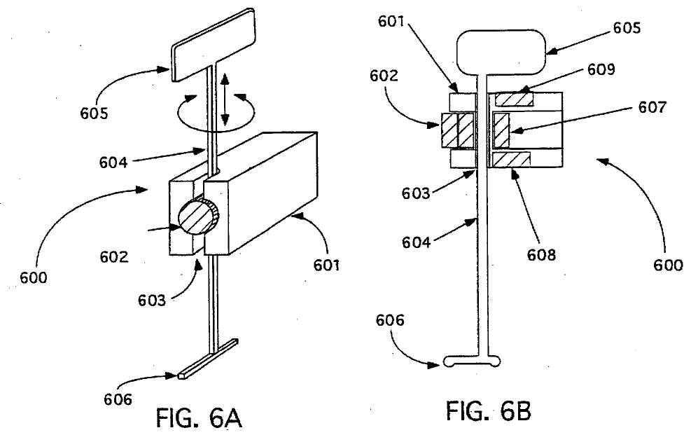

FIG. 1 shows that the heated platen that makes contact with the seal when the force to press the platen onto the seal is provided by actuating hold-down arm 109. However, when inserting a seal, as taught in the aforementioned patents issued to Chitouras, and utilizing solder pads similar to pads 46 through 49 shown in FIG. 5, no such force exists unless externally supplied. In U.S. Pat. No. 5,876,541, pressure is typically supplied with the use of magnetic forces supplied by various tools, such as shown in FIGS. 5, 8, 9, 10, and 11 of the patent. To accomplish similar functions with insertion tools as shown in FIG. 5 in this application, and where no means of supplying magnetic means may be used because of the redesign of toner cartridges by the original equipment manufacturer so as to preclude their use, a preferred embodiment of a force actuator is shown in FIGS. 6A and 6B.

FIG. 6A is a schematic representation of a preferred version of a pressure system 600 consisting of a bearing block 601 and pressure pin 604. Front magnet 602 is shown, bearing upon the front surface of pressure pin 604, which rests within and slides along guide track 603. Not shown are additional magnet(s) supporting pressure pin 604 on its back surface. Handle 605 is attached to pressure pin 604 to allow for the rotation of pressure pin 604 as well as for pushing/pulling foot 606 up and down to provide pressure against an insertion tool (not shown).

FIG. 6B is a cross sectional view of this preferred version of a pressure system 600. As in FIG. 6A, pressure system 600 consists of bearing support 601 supporting pressure pin 604 sliding or rotating within guide track 603 and supported by the use of various magnets, in this depiction consisting of two front magnets 602, one rear magnet 607, one top magnet 609 and one bottom magnet 608. Front magnets 602 produce a relatively high friction force on pressure pin 604, and provide a firm vertical holding position in conjunction with rear magnet 607. Top magnet 609 produces a downward force on pressure pin 604 and foot 606, even overcoming the friction force produced by front magnets 602 and rear magnet 607 on pressure pin 604 when handle 605 is within about one millimeter (0.040 in) of top magnet 609, thus producing a continual downward force on the insertion tool on which foot 606 is pressing. Bottom magnet 608 can be effectively used to modulate or vary magnetic flux throughout the magnetic paths within pressure system 600 to affect frictional force, pull down force and vertical stability force of pressure pin 604, which can be overridden by thumb force pressure on front magnet 602. In some embodiments, a magnet may be replaced with a high magnetic permeability material, such as soft iron so as to bring about an additional control of the magnetic flux flow through bearing block 601, for example, to produce a precise vertical force on pressure pin 604. With the flexibility possible as described above, foot 606 can be positioned in one direction to allow for its insertion within a cartridge being sealed and then rotated ninety degrees to provide proper forces against the insertion tool in order to provide proper sealing conditions for an inserted seal. Employing neodymium-iron-boron magnets about 12.7 mm (0.5 in) diameter and about five millimeter (0.2 in) in height, hold down forces of over about one kilogram (2.2 pounds) are readily generated and are also readily modified and controlled by magnetic strength selection and placement of the magnets. This preferred embodiment of a pressure system eliminates large, cumbersome weights, hinges and springs which would otherwise be required and which would generally be more costly.

While this invention has been particularly shown and described with references to preferred embodiments thereof, it will be understood by those skilled in the art that various changes in form and details may be made therein without departing from the scope of the invention encompassed by the appended claims, particularly in view of the continual modifications in cartridge designs by the original equipment manufacturers.

What is claimed is:

1. A device for resealing a toner cartridge, comprising:
a) a base for positioning a split toner cartridge, said split toner cartridge having a toner cartridge surface for receiving a replacement seal and adhesive; and
b) a platen having a platen surface that is substantially aligned with the toner cartridge surface for receiving the replacement seal and adhesive when the platen is pressed against said toner cartridge surface wherein said platen includes a portion that varies in elevation over at least part of the platen surface.

2. The device of claim 1 wherein said portion that varies in elevation over at least part of the platen surface is curved.

3. The device of claim 2 has a variation in platen elevation in a range of between about 0.0762 and 6.35 millimeters (3 and 250 mils).

4. The device of claim 1 which further includes a bottom support.

5. The device of claim 1 wherein said portion that varies in elevation over at least part of the platen surface includes an arc.

6. The device of claim 5 wherein said portion that varies in elevation over at least part of the platen surface further includes a second arc.

7. The device of claim 1 wherein said platen is attached to support members which can pivot about an axis.

8. The device of claim 7 wherein said support member include a pull down arm with arm stops that can engage said hold down arm to control pressure applied by said platen to said toner cartridge surface.

9. The device of claim 1 wherein said platen is in contact with a heater assembly.

10. The device of claim 1 wherein said adhesive includes a hot melt adhesive.

11. The device of claim 1 wherein said adhesive includes a pressure sensitive adhesive.

12. The device of claim 1 wherein a rod is removeably inserted in said platen and can be heated by said platen.

13. A platen for resealing a toner cartridge, comprising a raised surface which corresponds substantially with the toner cartridge surface for receiving a replacement seal and adhesive, wherein said raised surface varies in elevation over at least a portion of the platen surface.

14. The platen of claim 13 wherein said portion that varies in elevation over at least part of the platen surface includes an arc.

15. The platen of claim 13 wherein said portion that varies in elevation over at least part of the platen surface includes a curve.

16. A method for resealing a toner cartridge comprising:
a) positioning a split toner cartridge in a base, said split toner cartridge having a toner cartridge surface for receiving a replacement seal and adhesive;
b) positioning a seal with an adhesive attached thereto so that the adhesive is in contact with the toner cartridge surface for receiving the seal and adhesive; and
c) applying a platen having a platen surface that is substantially aligned with the toner cartridge surface for receiving the replacement seal and adhesive, whereby said platen, which includes a portion that varies in elevation over at least part of the platen surface, is pressed against said seal for applying to said toner cartridge, thereby resealing said toner cartridge.

17. The method of claim 16 wherein said position that varies in elevation over at least part of the platen surface is curved.

18. The method of claim 16 wherein said platen is sufficiently heated to melt said adhesive.

19. The method of claim 16 wherein a support for the bottom of said cartridge is inserted in said base.

20. The method of claim 16 wherein said platen includes a variation in platen elevation in a range of between about 0.0762 and 6.35 millimeters (3 and 250 mils).

21. The method of claim 16 includes pivoting support members, which have said platen attached thereto, about an axis to direct said platen against said toner cartridge surface.

22. The method of claim 21 which includes positioning on said support member a pull-down arm with arm stops that can engage said hold-down arm to control pressure applied by said platen to said toner cartridge surface.

23. The method of claim 16 wherein a heated rod is applied to a small area of the seal that is not adhered to the cartridge surface to cause said seal adhere in said area.

24. An insertable blade for sealing a toner cartridge, wherein said blade includes a plurality of raised pads.

25. The blade of claim 24, wherein said pads are formed from solder.

26. The blade of claim 24, wherein said pads include shapes selected from circles, ovals and rectangles.

27. The blade of claim 24, wherein said pads include a plurality of heights that can conform a seal to a toner cartridge sealing area.

28. A system for applying pressure to an object, comprising:
a) a block,
b) a pin formed from a magnetic material longitudinally slidable through said block and rotatable within said block about its axis, whereby said pin can contact said object, said pin having a handle at said proximate end, wherein said handle is shaped to engage said block and limit passage of said pin through said block,
c) a first magnet positioned to magnetically engage said pin and hinder longitudinally movement of the pin along said axis; and
d) a second magnet positioned to magnetically engage said handle in place against said block.

29. The system of claim 28 wherein said pin includes a foot on said distal end for applying force to the object.

30. The system of claim 28 wherein said system further includes a third magnet to magnetically engage the pin.

31. A toner cartridge resealing device having a plurality of systems in claim 28 for applying pressure to an insertable blade against a seal and toner cartridge.
